(19) United States
(12) Patent Application Publication
(10) Pub. No.: US 2007/0035376 A1
(43) Pub. Date: Feb. 15, 2007

(54) Circuit breaker

(76) Inventor: Albert Huang, Taipei (TW)

Correspondence Address: BACON & THOMAS, PLLC, 625 SLATERS LANE, FOURTH FLOOR, ALEXANDRIA, VA, 22314, US

(21) Appl. No.: 11/203,086

(22) Filed: Aug. 15, 2005

(51) Int. Cl. H01H 71/16

(52) U.S. Cl. 337/66

(57) ABSTRACT

A circuit breaker has a first and a second conducting strip respectively mounted in a lower end of a shell; a first terminal mounted on an upper end of the second conducting strip; a bimetal strip longitudinally mounted on an upper end of the first conducting strip; a second terminal detachably in contact with the first terminal; a button mounted on an upper end of the shell; and an arm pivotally mounted in an interior of the shell. An upper end of the bimetal strip is securely connected to a lower end of the arm. When the current is excessively high, the distortion of the bimetal strip in turn drives the arm and the button. The switch angle of the button is much bigger via the leg so that the switch angle of the button is obvious.

### BACKGROUND OF THE INVENTION

1. Field of the Invention

The present invention relates to a circuit breaker, and more particularly to a circuit breaker which can interrupt an excessively high electrical current consumption.

2. Description of Related Art

A circuit breaker is provided in a distribution box to prevent a high electrical current consumption from causing an accident. The circuit breaker is composed of a shell, a first and a second conducting strip provided in the shell, and a bimetal strip securely mounted on an upper end of the first conducting strip. The bimetal strip, i.e., two metal flats which have different thermal expansion factors, can electrically connect to the second conducting strip.

When an electrical current is excessively high and generates dangerous heat, the bimetal strip becomes heated and distorts, whereby a tip of the bimetal strip separates from the second conducting strip. Hence, the electrical current circuit is interrupted to prevent the overload of the current consumption.

Whether the circuit breaker has an action function depends on the flexibility of the bimetal strip. The bimetal strip of a conventional circuit breaker is pressed by a button. If a distortion power of the bimetal strip caused by the heavy current consumption is bigger than a friction from the button, the bimetal strip can separate from the second conducting strip. If the friction from the button is too big for the bimetal strip to act quickly, an electrical appliance may be damaged because of the heavy current not being timely interrupted.

With reference to FIG. 5, a conventional circuit breaker has a shell (not numbered), a first conducting strip (40) and a second conducting strip (41) respectively provided on a lower end of the shell. A first terminal (42) is mounted on an upper end of the second conducting strip (41) and a bimetal strip (50) is securely mounted on an upper end of the first conducting strip (40). A second terminal (51), which is provided on an upper end of the bimetal strip (50), corresponds to the first the first terminal (42). When the first terminal (42) is in contact with the second terminal (51), the circuit is complete. A button (60), which is provided on an upper end of the shell, is securely connected to the bimetal strip (50) and the second terminal (51).

With reference to FIG. 6, when the circuit is excessively high thereby the bimetal strip (50) being heated and distorted, the button (60) is directly driven by the distortion of the bimetal strip (50) thereby switching to an ‘off’ position, that is in a ‘current interrupt’ mode. However, the switch angle of the button is limited by the distortion of the bimetal strip such that the switch movement angle is only 10 degrees. Hence, the distinction between the ‘ON’ and ‘OFF’ positions of the button is not very obvious.

Therefore, the invention provides a circuit breaker to mitigate or obviate the aforementioned problems.

### SUMMARY OF THE INVENTION

The main objective of the present invention is to provide a circuit breaker, a button of which has an obvious position distinction between ‘ON’ and ‘OFF’ positions.

Other objectives, advantages and novel features of the invention will become more apparent from the following detailed description when taken in conjunction with the accompanying drawings.

### BRIEF DESCRIPTION OF THE DRAWINGS

FIG. 1 is a side view of a circuit breaker in a ‘current flow’ mode in accordance with the present invention;

FIG. 2 is a side view of the circuit breaker in a ‘current interruption’ mode in accordance with the present invention;

FIG. 3 is a comparison diagram between a switch angle of a conventional button and a first button of the circuit breaker in accordance with the present invention;

FIG. 4 is a comparison diagram between a switch angle of the conventional button and a second button of the circuit breaker in accordance with the present invention;

FIG. 5 is a side view of a conventional circuit breaker in a ‘current flow’ mode; and

FIG. 6 is a side view of the convention circuit breaker in a ‘current interruption’ mode.

### DETAILED DESCRIPTION OF THE PREFERRED EMBODIMENT

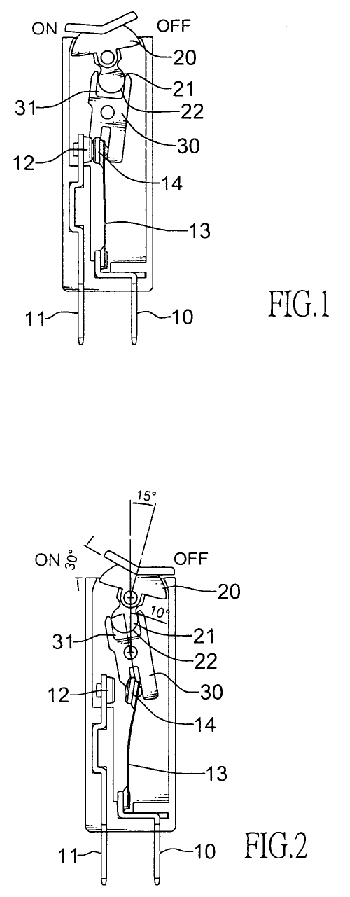

With reference to FIG. 1, a circuit breaker has a shell, a first conducting strip (10) and a second conducting strip (11) respectively mounted on a lower end of the shell. A first terminal (12) is provided on an upper end of the second conducting strip (11) and a bimetal strip (13) is longitudinally mounted on an upper end of the first conducting strip (10). A second terminal (14), which is mounted on an upper end of the bimetal strip (13), corresponds to and is in contact with the first terminal (12). A button (20) is pivotally mounted on an upper end of the shell wherein a lobe-like leg (21) is formed at a lower end of the button (20). An arm (30), which is pivotally mounted in an interior of the shell, has a channel (31) defined in an upper end thereof so that the leg (21) can be received into the channel (31) and pivot relative to the arm (30). A lower end of the arm (30) is securely connected to the upper end of the bimetal strip (13).

Still referring to FIG. 1, when the button (20) is switched on, that is in the ‘ON’ position, the first terminal (12) is in contact with the second terminal (14) so that the circuit breaker is in a ‘current flow’ mode.

With reference to FIG. 2, when the current is excessively high, the bimetal strip (13) is heated and distorted so that the second terminal (14) is separated from the first terminal (12) and the present invention is in a ‘current interruption’ mode. Furthermore, the arm (30) is driven by the bimetal strip (13) to pivot and the button (20) switches off by the movement of the arm (30), that is in an ‘OFF’ position.

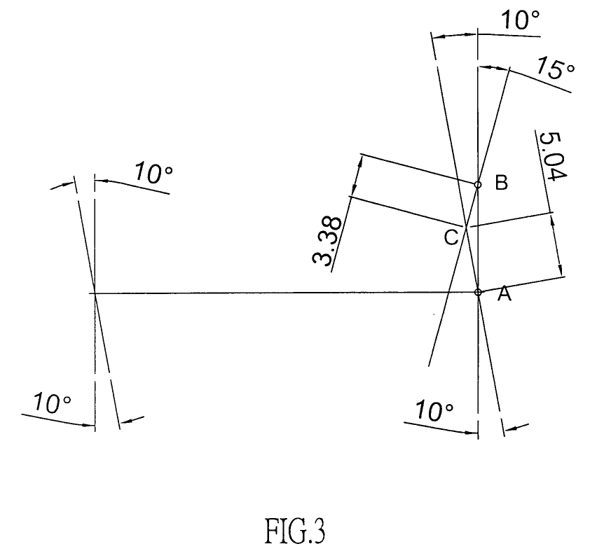

With reference to FIG. 3, a pivot point of the arm (30) is point ‘A’, a pivot point of the button (20) is point ‘B’, and an action point of the button (20) and the arm (30) is point ‘C’. In a triangle of ‘ABC’, AC, which is 5.04 mm in length, is longer than BC, which is 3.38 mm in length. The longest side AB of the triangle is opposed to the largest angle at point C and an angle of 15 degrees at point ‘B’ is bigger than an angle of 10 degrees at point ‘A’. Thus, in a ‘current flow’ mode, the second terminal (14) is in contact with the first terminal (12) and the button (20) is in a first position, and in a ‘current interruption’ mode, the second terminal (14) is separated from the first terminal (12) by distortion of the bimetal strip (13) such that the lower end of the arm (30) pivots a first angle in a first direction causing the button (20) via the leg (21) to pivot in a second direction opposite to the first direction to a second position that is pivoted relative to the first position at an angle greater than the first angle. Hence, comparing with the conventional switch angle of the button shown at the left in FIG. 3, the switch angle of the button in accordance with the present invention is bigger so that the switch angle of the button is obvious.

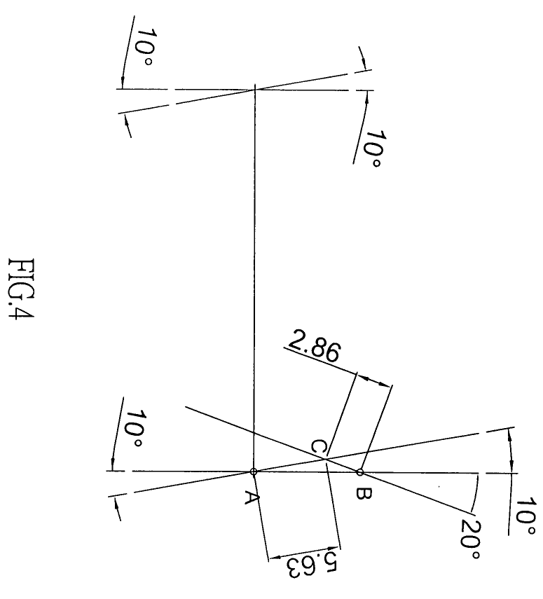

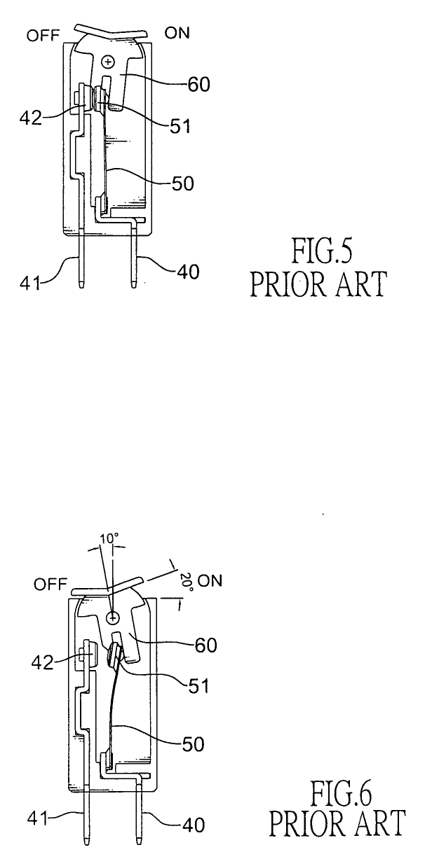

With reference to FIG. 4, a pivot point of the arm (30) is point ‘A’, a pivot point of the button (20) is point ‘B’, and an action point of the button (20) and the arm (30) is point ‘C’. In a triangle of ‘ABC’, AC, which is 5.63 mm in length, is longer than BC, which is 2.86 mm in length. The longest side of the triangle is opposed to the biggest angle and an angle of 20 degrees at ‘B’ is bigger than an angle of 10 degrees at ‘A’. Hence, comparing with the conventional switch angle of the button shown at the left in FIG. 4, the switch angle of the button in accordance with the present invention is much bigger so that the switch angle of the button is obvious.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A circuit breaker comprising:
a shell,
a first conducting strip (10) and a second conducting strip (11) respectively mounted in a lower end of the shell;
a first terminal (12) mounted on an upper end of the second conducting strip (11);
a bimetal strip (13) longitudinally mounted on an upper end of the first conducting strip (10);
a second terminal (14) mounted on an upper end of the bimetal strip (13) and corresponding to and detachably in contact with the first terminal (12);
a button (20) pivotally mounted on an upper end of the shell;
a leg (21) formed in a lower end of the button (20); and
an arm (30) pivotally mounted in an interior of the shell and having a channel (31) defined in an upper end thereof wherein the leg (21) is pivotally received into the channel (31) and an upper end of the bimetal strip (13) is securely connected to a lower end of the arm (30), a distance between a pivot point of the arm (30) and an action point of the button (20) and the arm (30) is larger than a distance between a pivot point of the button (20) and the action point of the button (20) and the arm (30) whereby in a ‘current interruption’ mode, the second terminal (14) is in contact with the first terminal (12) and the button (20) is in a first position, and in a ‘current interruption’ mode, the second terminal (14) is separated from the first terminal (12) by distortion of the bimetal strip (13) such that the lower end of the arm pivots a first angle in a first direction causing the button (20) via the leg to pivot in a second direction opposite to the first direction to a second position that is pivoted relative to the first position at an angle greater than the first angle.

2. The circuit breaker as claimed in claim 1, wherein the leg (21) has a lobe appearance.
